(19) United States
(12) Patent Application Publication
(10) Pub. No.: US 2021/0024221 A1
(43) Pub. Date: Jan. 28, 2021

(54) LEADING EDGE MEMBER FOR AN AIRFOIL OF AN AIRCRAFT

(71) Applicants: Airbus Operations SAS, Toulouse (FR); Airbus Operations GmbH, Hamburg (DE)

(72) Inventors: Florent HUET, Hamburg (DE); Stefan BENSMANN, Hamburg (DE); Marcus ERBAN, Hamburg (DE); Andreas GELLERT, Hamburg (DE); Martin FEES, Hamburg (DE)

(21) Appl. No.: 16/938,227

(22) Filed: Jul. 24, 2020

(30) Foreign Application Priority Data
Jul. 25, 2019 (DE) 102019120170.5

(51) Int. Cl. B64D 15/04; B64C 3/28; B64C 3/18; B64D 13/06

(52) U.S. Cl. CPC B64D 15/04; B64C 3/28; B64D 2013/0618; B64D 13/06; B64D 2013/0607; B64C 3/187

(57) ABSTRACT

A leading edge member, an airfoil and an aircraft using the leading edge member to improve de-icing capacity by recirculating hot bleed air in a spanwise direction and to increase the mass and heat flow within the leading edge member. The hot bleed air is injected via an inlet arrangement into a forward hot air chamber defined by the outer skin of the leading edge member and the front spar. Subsequently, the hot air flow travels through a connecting passage opening from the forward hot air chamber through the front spar into the aft hot air chamber. Subsequently, the hot air flows along the entire spanwise length within the aft hot air chamber and splits into an exhaust flow and a recirculation flow. The recirculation flow passes through a recirculation opening and mixes with new hot bleed air, to take another round trip within the leading edge member.

### CROSS-REFERENCES TO RELATED APPLICATIONS

This application claims the benefit of the German patent application No. 102019120170.5 filed on Jul. 25, 2019, the entire disclosures of which are incorporated herein by way of reference.

### FIELD OF THE INVENTION

The invention relates to a leading edge member. Furthermore, the invention relates to an airfoil and an aircraft equipped with the leading edge member.

### BACKGROUND OF THE INVENTION

U.S. Pat. No. 6,467,730 B2 discloses a leading edge member of an airfoil. The leading edge member has a de-icing device for circulating hot air in the direction of the wingspan of the airfoil.

U.S. Pat. No. 9,896,190 B1 discloses a wing leading edge architecture. The wing leading edge has a single hot air compartment and circulates the hot air in a chordwise direction.

U.S. Pat. No. 8,757,547 B2 discloses an aircraft nacelle having a duct for circulating hot air and an injection element for injecting the hot air.

### SUMMARY OF THE INVENTION

It is an object of the invention to improve the de-icing capacity in aircraft.

This object is achieved by the subject-matter of the independent claims. The dependent claims are directed at advantageous embodiments.

The invention provides a leading edge member of an airfoil of an aircraft, the leading edge member having an outer skin and a de-icing device, the de-icing device comprising a forward hot air chamber and an aft hot air chamber, the forward and aft hot air chambers extending along a spanwise direction of the leading edge member and being separated by a separation wall along the spanwise direction, the separation wall being configured so as to allow for a circular hot airflow in the spanwise direction; and an inlet arrangement having at least one inlet opening for injecting hot air, the inlet arrangement configured for generating a circular hot air flow within the de-icing device, wherein the de-icing device is configured in such a manner that the circular hot air flow causes a hot air recirculation flow from the aft hot air chamber to the forward hot air chamber.

Preferably, the de-icing device is configured to guide the circular hot airflow along the entire spanwise length of the leading edge member.

Preferably, the separation wall is configured so as to prevent circular hot airflow in a chordwise direction of the leading edge member.

Preferably, the separation wall is configured so as to only allow circular hot airflow in the spanwise direction.

Preferably, the forward circular hot air flow in the forward hot air chamber is directed from inboard to outboard.

Preferably, the aft circular hot air flow in the aft hot air chamber is directed from outboard to inboard.

Preferably, the de-icing device comprises a recirculation opening which fluidly connects the aft hot air chamber to the forward hot air chamber and which is arranged such that the hot air recirculation flows from the aft hot air chamber through the recirculation opening to the forward hot air chamber.

Preferably, the recirculation opening is arranged at the inboard end portion of the leading edge member.

Preferably, the de-icing device comprises a connecting passage opening which fluidly connects the forward hot air chamber to the aft hot air chamber and is spaced apart from the inlet arrangement in the spanwise direction so that the hot air flow is guided along the entire spanwise length of the leading edge member.

Preferably, the connecting passage opening is arranged at the outboard end portion of the leading edge member.

Preferably, the connecting passage opening is arranged at the opposite end portion in the spanwise direction from the recirculation opening.

Preferably, the connecting passage opening is formed in the separation wall.

Preferably, the recirculation opening is formed in the separation wall.

Preferably, the de-icing device comprises an exhaust opening arranged so that the circular hot air flow is split into the recirculation flow and an exhaust flow, which is exhausted from the leading edge member.

Preferably, the exhaust opening is arranged at the same end portion as the inlet arrangement.

Preferably, the exhaust opening is arranged at the inboard end portion of the leading edge member.

Preferably, the exhaust opening is arranged at the same end portion as the recirculation opening.

Preferably, the de-icing device comprises a recirculation compartment arranged at an end portion, in particular the inboard end portion, of the leading edge member, the recirculation compartment containing the inlet arrangement.

Preferably, the recirculation compartment contains the recirculation opening.

Preferably, the recirculation compartment contains the exhaust opening.

Preferably, the recirculation compartment is defined in the spanwise direction between an inner end rib and an adjacent rib of the leading edge member.

Preferably, the separation wall is formed by a spar of the leading edge member.

Preferably, the leading edge member comprises by a rib member configured for supporting the outer skin, the rib member comprising at least one rib slot within each of the forward hot air chamber and the aft hot air chamber, each recess being configured to form a passageway for the circular hot air flow in cooperation with the outer skin.

Preferably, the inlet arrangement comprises an feeding tube, the feeding tube having a plurality of inlet openings formed in the circumferential surface of the feeding tube.

Preferably, the inlet arrangement comprises an air deflection device configured to direct the hot air flow from the inlet openings in the spanwise direction.

Preferably, the air deflection device includes the inlet openings, and the inlet openings are formed or tilted such that the hot airflow is directed in the spanwise direction.

Preferably, the air deflection device includes a deflector which is disposed on the circumferential surface of the feeding tube, the deflector being configured so as to direct the hot airflow in the spanwise direction.

Preferably, the feeding tube extends through the leading edge member and is configured to supply another leading edge member with hot air.

Preferably, the inlet arrangement comprises an inlet device having a mixing opening and a plurality of inlet openings circumferentially arranged around the mixing opening such that the recirculation flow flows through the mixing opening and mixes with the newly injected hot air.

Preferably, the inlet openings are arranged such that their respective central axes converge.

Preferably, the inlet arrangement is arranged at the inboard end portion of the leading edge member.

The invention provides an airfoil for an aircraft comprising a preferred leading edge member, wherein the leading edge member is movably or immovably attached to the airfoil.

The invention provides a wing for an aircraft comprising a preferred leading edge member, wherein the leading edge member is movably or immovably attached to the wing.

The invention provides an aircraft comprising a preferred leading edge member or a preferred airfoil or wing.

Advantageous effects of the invention are described in more detail below. It should be noted that not all advantageous effects need to be present at the same time or with the same intensity.

Usually, in anti-ice leading edge devices, hot air is used from the engine and transported via the bleed duct through the fixed leading edge member and subsequently passed on to a movable leading edge member, such as a slat. The bleed air can then be transferred via a telescopic duct into the slat box. Previously the slat box contained a so-called piccolo tube to de-ice the slat and if necessary, to transfer the bleed air from slat to slat via a hose, for example. With this configuration, however, the hot air is only used once and then leaves the slat

The invention is based on the idea to reuse the hot air more than once to increase the heat flow into the (top) skin due to re-circulation of the hot air in the slat. Previously, the hot air was injected into the front bay of the leading edge member and subsequently passed through an opening in the spar, so as to enter the aft bay of the leading edge member. Subsequently, the air flow is exhausted through an opening in the aft bay to the environment. In particular, the mass flow which enters the aft bay can be accelerated through an acceleration slot before leaving the aft bay through the exhaust holes. It should be noted, that in this configuration the air flow is directed chordwise. The hot air transfers the heat into the top skin along this path only once.

In contrast, the invention proposes to increase the heat transfer to the top skin by increasing the mass flow within the leading edge member or slat. This can be achieved by reusing air from the aft bay which is recirculated using a kind of Venturi effect to create a low pressure zone that causes the air to flow from the aft bay back into the front bay. In this concept the hot air flow is in spanwise direction along the entirety of the leading edge member. There can be openings to connect the front bay with the aft bay at both ends of the leading edge member or slat.

To improve or generate this Venturi-like effect, an air deflector may be used to direct incoming hot bleed air towards the outboard end. At the end of the deflector a low pressure zone is generated which will then draw the air from the inboard end of the leading edge member or slat.

The air from the inboard end can subsequently vent through an opening in the front spar. Slots may be formed in the ribs to guide the air directly along the top skin in the spanwise direction.

In an advantageous embodiment there can be more than one area where hot air may get out of the transfer tube.

In another concept, the Venturi-like effect can be generated by a feed ring which directs the incoming hot air towards the outboard end. The hot air can flow in the spanwise direction. The feed ring allows creation of a low-pressure zone on one side of the feed ring. Due to the annular shape, the air in the aft bay at the inboard end of the leading edge member or slat is drawn to the front bay and accelerated through the feed ring's opening. Again, the ribs can have slots to guide the air directly along the top skin.

### BRIEF DESCRIPTION OF THE DRAWINGS

Embodiments of the invention are described in more detail with reference to the accompanying drawings.

FIG. 1 depicts an aircraft according to the invention;

FIG. 2 depicts a top view of a leading edge member;

FIG. 3 depicts a cross section along III-III of the leading edge member of FIG. 2;

FIG. 4 depicts a cross section along IV-IV of the leading edge member of FIG. 2;

FIG. 5 depicts detail A of the leading edge member of FIG. 2;

FIG. 6 depicts a top view of another leading edge member;

FIG. 7 depicts cross section VII-VII of the leading edge member of FIG. 6;

FIG. 8 depicts cross section VIII-VIII of the leading edge member of FIG. 6; and

FIG. 9 depicts an inlet device of the leading edge member of FIG. 6.

### DETAILED DESCRIPTION OF THE PREFERRED EMBODIMENTS

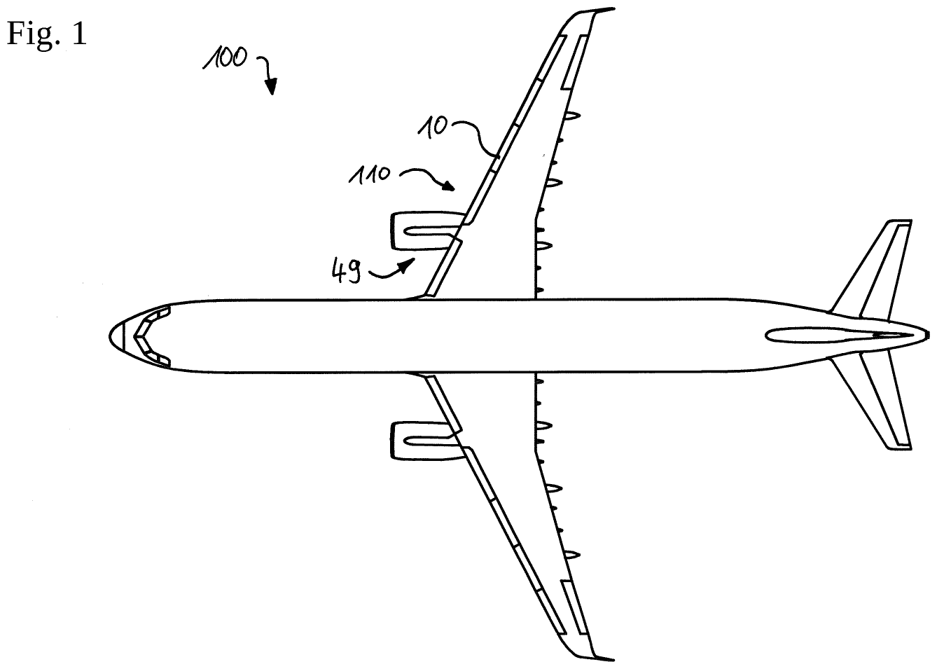

FIG. 1 depicts an aircraft 100 having a pair of wings 110. At least one of the wings 110 is equipped with a leading edge member 10 according to the invention. The wing 110 is an example for an airfoil. In this embodiment, the leading edge member 10 is movably attached to the wing 110. It should be noted that in other embodiments, the leading edge member 10 may be immovably fixed to the wing 110.

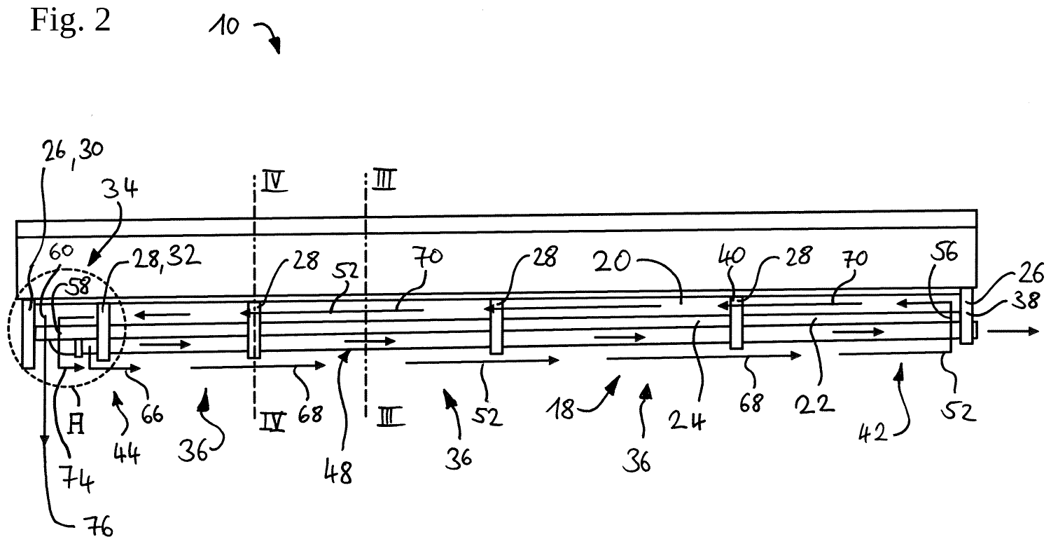

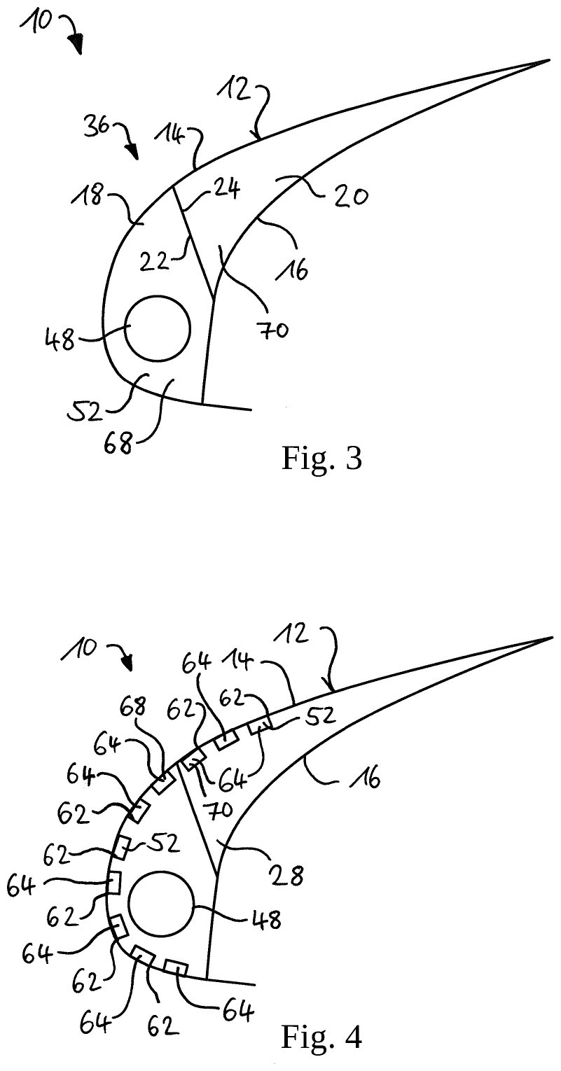

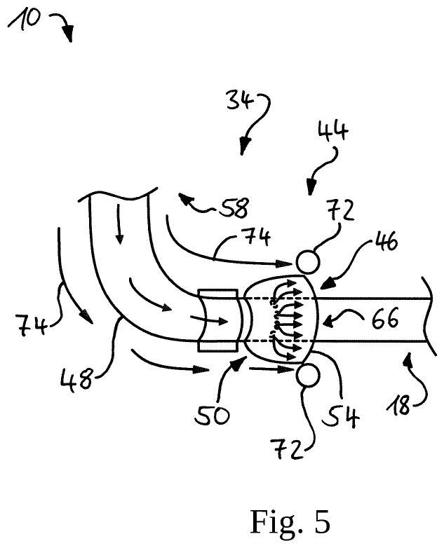

Reference is made to FIGS. 2 to 5, which depict an embodiment of the leading edge member 10. Preferably the leading edge member 10 is a movable leading edge member, such as a slat.

The leading edge member comprises an outer skin 12, which during flight, guides the impinging air flow.

The outer skin 12 may have a top skin portion 14, which during flight faces the impinging air flow. Furthermore, the outer skin 12 may have a back skin portion 16, which faces the opposite direction of the top skin portion 14.

The leading edge member 10 includes a forward hot air chamber 18 and an aft hot air chamber 20. Furthermore, the leading edge member 10 includes a separation wall 22, which separates the forward hot air chamber 18 from the hot air chamber 20. The separation wall 22 may simultaneously be configured as a front spar 24.

The leading edge member 10 comprises two end ribs 26, which are arranged at opposite ends in a spanwise direction of the leading edge member 10.

A plurality of ribs 28 is interposed and distributed along the spanwise direction between the end ribs 26.

An inboard end rib 30 and an adjacent rib 32 define a recirculation compartment 34 in the spanwise direction. Additional compartments 36 may be defined by the remaining ribs 28 and an outboard end rib 38.

The recirculation compartment 34 and the additional compartments 36 include respective adjacent portions of the forward hot air chamber 18 and the aft hot air chamber 20.

The outboard end rib 38 and an adjacent inboard rib 40 define a circulation compartment 42 in the spanwise direction.

The leading edge member 10 comprises an inlet arrangement 44, which is preferably disposed in the recirculation compartment 34 at the inboard end portion of the leading edge member 10. The inlet arrangement 44 is configured to cause a circular hot air flow 52.

The inlet arrangement 44 comprises a plurality of inlet openings 46. Preferably, the inlet openings 46 are formed in a circumferential surface of a feeding tube 48. The feeding tube 48 is supplied with hot bleed air from aircraft engines 49. The feeding tube 48 enters the leading edge member in the recirculation compartment 34 and extends through all additional compartments 36 towards and preferably beyond the outboard end rib 38, so as to be able to supply a neighboring leading edge member (not depicted) with hot bleed air. The neighboring leading edge member may have the same configuration as the leading edge member 10.

The inlet arrangement 44 may be the only ingress for hot bleed air. In particular, the inlet openings 46 are preferably the only openings in the feeding tube 48 which communicate with the forward hot air chamber 18 and/or the aft hot air chamber 20.

The inlet arrangement 44 may further comprise an air deflection device 50, which is preferably disposed on the circumferential surface of the feeding tube 48. The air deflection device 50 is configured to direct the hot bleed air injected by the inlet openings 46 in the spanwise direction, so as to cause the circular hot air flow 52.

The air deflection device 50 may include a deflector 54, which is fixed to or formed on the circumferential surface of the feeding tube 48. The deflector 54 may be configured as a cup-shaped member. The open end of the deflector 54 preferably faces to the outboard end of the leading edge member 10. The deflector 54 may be implemented by bending a metal sheet or the like.

The leading edge member 10 further includes a connecting passage opening 56, which may be formed in the separation wall 22. The connecting passage opening 56 is preferably disposed at the outboard end of the leading edge member 10 directly adjacent to the outboard end rib 38. It should be noted that the connecting passage opening 56 may be formed as a single opening or a group of smaller openings, which nearly cover the same area as a single connecting passage opening.

The connecting passage opening 56 allows for fluid communication between the forward hot air chamber 18 and the aft hot air chamber 20.

The leading edge member 10, preferably the separation wall 22 comprises a recirculation opening 58. The recirculation opening 58 may similarly be formed as a group of smaller recirculation openings which cover roughly the same area as the single recirculation opening. The recirculation opening 58 is arranged at the inboard end of the leading edge member, preferably directly adjacent to the inboard end rib 30. The recirculation opening 58 is arranged within the recirculation compartment 34.

The leading edge member 10 includes an exhaust opening 60. The exhaust opening 60 may again also be formed as a group of smaller exhaust openings, which nearly cover the same area as a single exhaust opening.

The exhaust opening 60 fluidly connects the aft hot air chamber 20 with the environment.

The exhaust opening 60 is preferably arranged at the inboard end of the leading edge member 10, in particular also within the recirculation compartment 34.

Each rib 28 may include a plurality of rib slots 62. At least one rib slot 62 is arranged in each of the forward hot air chambers 18 and the aft hot air chambers 20. Thus, the rib slots 62 allow for fluid communication between the recirculation compartment 34, the additional compartment(s) 36 and the circulation compartment 42.

Each rib slot 62 is preferably formed in the rib 28 in such a manner that incorporation with the outer skin 12, in particular the top skin portion 14, a hot air duct 64 is formed. Thus, the outer skin 12, in particular the top skin portion 14, may be efficiently heated using hot air.

Referring now to FIGS. 2 to 5, the operation of the leading edge member 10 regarding de-icing is described in more detail.

Initially, hot bleed air 66 is injected by the inlet arrangement 44 through the inlet openings 46 into the recirculation compartment 34 in the forward hot air chamber 18.

Subsequently, the hot bleed air 66 forms a forward hot air flow 68, which travels within the forward hot air chamber 18 from the inboard end towards the outboard end of the leading edge member 10 along the entire spanwise length.

At the outboard end of the leading edge member 10 just before the outboard end rib 38, the forward hot air flow 68 passes through the connecting passage opening 56 into the aft hot air chamber 20, thereby forming an aft hot air flow 70. The aft hot air flow 70 travels from the outboard end to the inboard end of the leading edge member 10 along the entire spanwise length.

After passing the adjacent outboard rib 32, the aft hot air flow 70 enters the recirculation compartment 34 in the aft hot air chamber 20.

Due to the configuration of the inlet arrangement 44, in particular the air deflection device 50, a low-pressure zone 72 is generated within the recirculation compartment 34 in the forward hot air chamber 18.

Thus, the aft hot air flow 70 is split into a recirculation flow 74 and an exhaust flow 76.

The recirculation flow 74 passes through the recirculation opening 58 into the low-pressure zone 72 and combines with the new hot bleed air 66 to take a further round trip within the leading edge member 10.

The exhaust flow 76 is ejected out of the leading edge member 10 into the environment.

As described above, the overall flow of mass and heat within the leading edge member 10, in particular the forward hot air chamber 18 and the aft hot air chamber 20 may be increased. In particular, the hot bleed air 66 may be used more than once before finally being ejected through the exhaust opening 60. Thus, a more efficient use of the hot bleed air 66 is possible and the de-icing capacity of the leading edge member 10 may be improved.

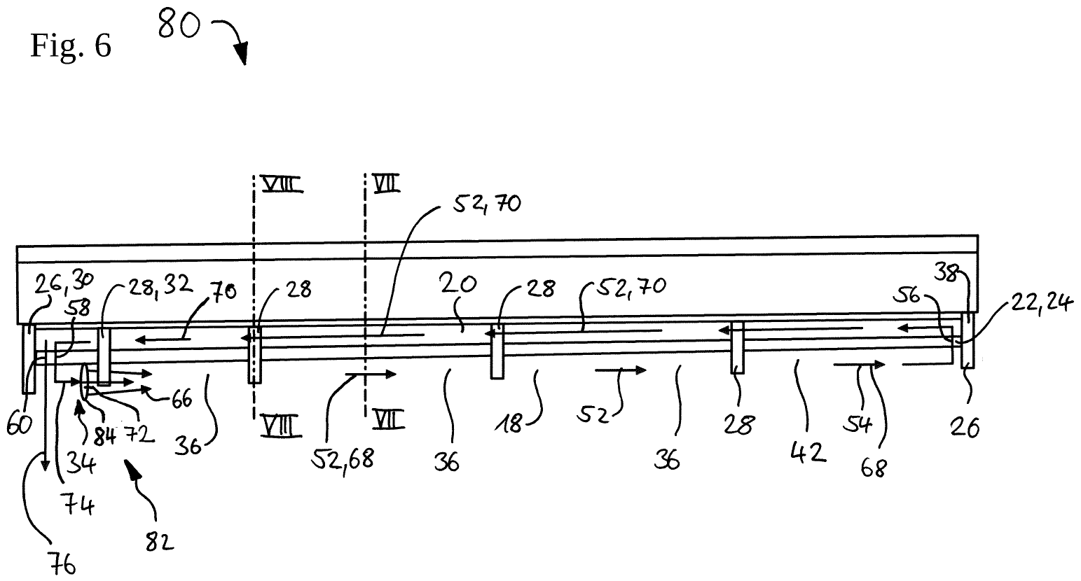

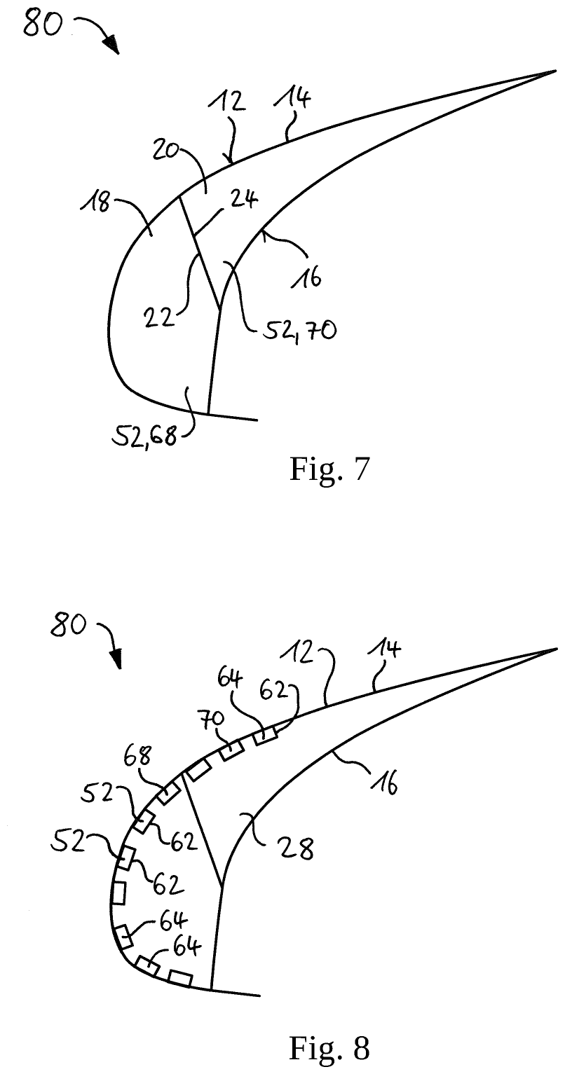

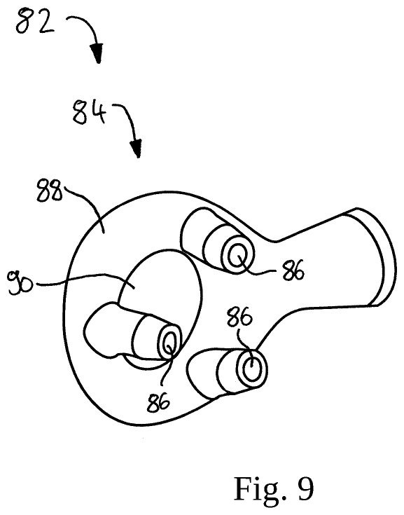

Referring now to FIGS. 6 to 9 a further embodiment of a leading edge member 80 is described insofar as it differs from the leading edge member 10.

As can be seen, in particular, from FIGS. 6 to 9, the leading edge member 80 has an inlet arrangement 82. The leading edge member 80 is without a feeding tube 48. Instead, the inlet arrangement 82 comprises an inlet device 84, which is supplied with the hot bleed air 66.

The inlet device 84 comprises a plurality of inlet openings 86. Furthermore, the inlet device 84 comprises a ring-shaped inlet device body 88. The inlet device 84 includes a mixing opening 90, which may be surrounded in a circumferential direction by the inlet device body 88.

The inlet openings 86 are distributed in a circumferential direction around the mixing opening 90. Furthermore, the inlet openings 86 may be tilted and configured in such a way that their respective central axes converge.

Similarly, to the first embodiment, in the second embodiment of the leading edge member 80 the injection of the hot bleed air 66 forms a low-pressure zone 72 around the inlet openings 86.

As a result, the recirculation flow 74 passes through the recirculation opening 58 and through the mixing opening 90 as well as around the inlet device body 88 so as to mix with the new hot bleed air 66 and subsequently making another round trip within the leading edge member 80.

In addition to an improved de-icing capacity, with this embodiment the weight of the leading edge member 80 is reduced, since it is not necessary to include a feeding tube.

It should be noted however, that this embodiment does not exclude the supply of hot bleed air 66 to other leading edge members.

In summary, the above-described invention provides a leading edge member, an airfoil and an aircraft using the leading edge member to improve the de-icing capacity by recirculating hot bleed air in a spanwise direction within the leading edge member. The hot bleed air is injected via an inlet arrangement into a forward hot air chamber defined by the outer skin of the leading edge member and the front spar. Subsequently, the hot air flow travels through a connecting passage opening from the forward hot air chamber through the front spar into the aft hot air chamber. Subsequently, the hot air flows along the entire spanwise length within the aft hot air chamber and splits into an exhaust flow and a recirculation flow. The recirculation flow passes through a recirculation opening and mixes with new hot bleed air, so as to take another round trip within the leading edge member. Thus, the mass and heat flow within the leading edge member may be increased and the residual heat of the recirculation flow may be used more efficiently.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 leading edge member
12 outer skin
14 top skin portion
16 back skin portion
18 forward hot air chamber
20 aft hot air chamber
22 separation wall
24 front spar
26 end rib
28 rib
30 inboard end rib
32 adjacent outboard rib
34 recirculation compartment
36 additional compartment
38 outboard end rib
40 adjacent inboard rib
42 circulation compartment
44 inlet arrangement
46 inlet openings
48 feeding tube
49 aircraft engine
50 air deflection device
52 circular hot air flow
54 deflector
56 connecting passage opening
58 recirculation opening
60 exhaust opening
62 rib slot
64 hot air duct
66 hot bleed air
68 forward hot air flow
70 aft hot air flow
72 low-pressure zone
74 recirculation flow
76 exhaust flow
80 leading edge member
82 inlet arrangement
84 inlet device
86 inlet openings
88 inlet device body
90 mixing opening
100 aircraft
110 wing (airfoil)

1. A leading edge member of an airfoil of an aircraft, the leading edge member having an outer skin and a de-icing device, the de-icing device comprising:
a forward hot air chamber and an aft hot air chamber, the forward and aft hot air chambers extending along a spanwise direction of the leading edge member and being separated by a separation wall along the spanwise direction, the separation wall being configured so as to allow for a circular hot air flow in the spanwise direction; and
an inlet arrangement having at least one inlet opening for injecting hot air, the inlet arrangement configured for generating a circular hot air flow within the de-icing device,
wherein the de-icing device is configured such that the circular hot air flow causes a hot air recirculation flow from the aft hot air chamber to the forward hot air chamber.

2. The leading edge member according to claim 1, wherein the de-icing device comprises a recirculation opening which fluidly connects the aft hot air chamber to the forward hot air chamber and which is arranged such that the hot air recirculation flows from the aft hot air chamber through the recirculation opening to the forward hot air chamber.

3. The leading edge member according to claim 2, wherein the de-icing device comprises a connecting passage opening which fluidly connects the forward hot air chamber to the aft hot air chamber and is spaced apart from the inlet arrangement in the spanwise direction so that the hot air flow is guided along an entire spanwise length of the leading edge member.

4. The leading edge member according to claim 3, wherein at least one of:
the connecting passage opening is arranged at an opposite end portion in the spanwise direction from the recirculation opening, or
at least one of the connecting passage opening or the recirculation opening is formed in the separation wall.

5. The leading edge member according to claim 1, wherein the de-icing device comprises an exhaust opening arranged so that the circular hot air flow is split into the recirculation flow and an exhaust flow which is exhausted from the leading edge member.

6. The leading edge member according to claim 1, wherein the de-icing device comprises a recirculation compartment arranged at an end portion of the leading edge member, the recirculation compartment containing the inlet arrangement.

7. The leading edge member according to claim 6, wherein the recirculation compartment is defined in the spanwise direction between an inner end rib and an adjacent rib of the leading edge member.

8. The leading edge member according to claim 1, further comprising a rib member configured for supporting the outer skin, the rib member comprising at least one rib slot within each of the forward hot air chamber and the aft hot air chamber, each recess being configured to form a passageway for the circular hot air flow in cooperation with the outer skin.

9. The leading edge member according to claim 1, wherein the inlet arrangement comprises an air deflection device configured to direct the hot air flow from the at least one inlet opening in the spanwise direction.

10. The leading edge member according to claim 9, wherein at least one of:
the air deflection device includes the at least one inlet opening, and the inlet opening is formed or tilted such that the hot airflow is directed in the spanwise direction, or the inlet arrangement comprises a feeding tube and the air deflection device includes a deflector which is disposed on a circumferential surface of the feeding tube, the deflector being configured so as to direct the hot air flow in the spanwise direction.

11. The leading edge member according to claim 1, wherein the inlet arrangement comprises a feeding tube, the feeding tube having a plurality of inlet openings formed in a circumferential surface of the feeding tube.

12. The leading edge member according to claim 11, wherein the feeding tube extends through the leading edge member and is configured to supply another leading edge member with hot air.

13. The leading edge member according to claim 1, wherein the inlet arrangement comprises an inlet device having a mixing opening and a plurality of inlet openings circumferentially arranged around the mixing opening such that the recirculation flow flows through the mixing opening and mixes with the newly injected hot air.

14. An airfoil for an aircraft comprising a leading edge member according to claim 1, wherein the leading edge member is movably or immovably attached to the airfoil.

15. An aircraft comprising a leading edge member according to claim 1.

16. An aircraft comprising an airfoil according to claim 14.
